(19) United States
(12) Patent Application Publication
(10) Pub. No.: US 2026/0129132 A1
(43) Pub. Date: May 7, 2026

(54) ELECTRONIC DEVICE AND IMAGE READING APPARATUS

(71) Applicant: BROTHER KOGYO KABUSHIKI KAISHA, Nagoya (JP)

(72) Inventor: Yasuo NISHIKAWA, Nagoya (JP)

(21) Appl. No.: 19/214,367

(22) Filed: May 21, 2025

(30) Foreign Application Priority Data
Nov. 5, 2024 (JP) 2024-193964

(51) Int. Cl. H04N 1/00

(52) U.S. Cl. CPC H04N 1/00559; H04N 1/00557; H04N 1/00795; H04N 2201/0081

(57) ABSTRACT

A movable body is movable inside a housing in first and second directions along a bottom surface. A flexible flat cable has one end attached to the movable body and an other end attached to a controller. The flexible flat cable has one flat surface and an other flat surface opposite to each other. A facing member is disposed at the movable body. The facing member includes a facing surface that faces the other flat surface of the flexible flat cable in a state where the one flat surface of the flexible flat cable faces a side surface. The facing member assists movement of the one flat surface of the flexible flat cable toward the side surface when the movable body moves toward the first direction. The facing surface extends toward the first direction from an end of the movable body in the first direction.

### REFERENCE TO RELATED APPLICATIONS

This application claims priority from Japanese Patent Application No. 2024-193964 filed on Nov. 5, 2024. The entire content of the priority application is incorporated herein by reference.

### BACKGROUND ART

An electronic device including a flexible flat cable connected to a movable body is known.

### SUMMARY

For example, an elastic member may be disposed at a carriage of a reading unit (scanner head) of an image scanner. In the image scanner, a flat cable attached to the reading unit includes a portion extending along the main body of the image scanner and a portion folded back in an arc shape so as to be separated from the main body. Providing the elastic member at the carriage reduces damage to the flat cable due to repeated contact between the folded portion of the flat cable and the reading unit.

However, the behavior of a portion of the flat cable extending along the main body of the image scanner is not particularly considered. When the reading unit moves between one side and the other side in the sub-scanning direction, if the portion of the flat cable extending along the main body is curved and repeatedly contacts the reading unit, the flat cable may be damaged as described above.

In view of the foregoing, an example of an object of this disclosure is to provide an electronic device configured to reduce contact of a flexible flat cable with a movable body due to curving of the flexible flat cable when the movable body moves.

According to one aspect, this specification discloses an electronic device. The electronic device includes a housing, a controller, a movable body, a flexible flat cable, and a facing member. The housing includes a side surface and a bottom surface. The movable body is movable inside the housing in a first direction and in a second direction along the bottom surface. The first direction and the second direction are opposite to each other. The first direction and the second direction are parallel to the side surface. The flexible flat cable has one end attached to the movable body and an other end attached to the controller. The flexible flat cable has one flat surface and an other flat surface opposite to each other. The facing member is disposed at the movable body. The facing member includes a facing surface that faces the other flat surface of the flexible flat cable in a state where the one flat surface of the flexible flat cable faces the side surface. The facing member is configured to assist movement of the one flat surface of the flexible flat cable toward the side surface when the movable body moves toward the first direction. The facing surface extends toward the first direction from an end of the movable body in the first direction. The facing surface contributes to assisting movement of the flexible flat cable toward the side surface when the movable body moves toward the first direction. According to another aspect, this specification also discloses an image reading apparatus. The image reading apparatus includes a housing, a reading unit, a flexible flat cable, and a guide. The housing includes a side surface and a bottom surface. The reading unit is movable inside the housing. The flexible flat cable is attached to the reading unit. The guide is disposed at a corner of the reading unit near the side surface. The guide is configured to assist movement of the flexible flat cable toward the side surface when the reading unit moves toward a particular direction.

In the electronic device of the present disclosure, the movable body moves in the first direction along the bottom surface of the housing and the second direction opposite to the first direction. The one end of the flexible flat cable is attached to a particular portion of the movable body that moves as described above, and the other end of the flexible flat cable is attached to the controller disposed outside the housing, for example.

The flexible flat cable extends from the other end along the side surface inside the housing, and then is folded back in an arc shape so as to be separated from the side surface, and the one end is attached to the movable body. Since the one end of the flexible flat cable also moves due to the movement of the movable body, the flexible flat cable is curved and deformed such that the arc shape of the folded portion expands and contracts, and the range in which the one flat surface and the side surface face each other changes in size, thereby following the movement.

At this time, since the one flat surface of the flexible flat cable and the side surface face each other and the portion of which the range changes in size is not attached to the side surface of the housing, the portion may be curved without closely following the side surface and may contact the movable body, and when such contact is repeated, the flexible flat cable may be damaged.

In the present disclosure, in order to cope with this, a facing member that moves together with the movable body is disposed at a particular portion of the movable body in the first direction. With this configuration, for example, when the movable body moves toward the first direction, even if the flat surface of the flexible flat cable is curved and not closely following the side surface of the housing, the movement is assisted so that one flat surface approaches the side surface, and is brought close to the side surface. This resultantly reduces contact between the flexible flat cable and the movable body and reduces damage to the flexible flat cable.

According to the present disclosure, when the movable body moves, this configuration reduces curving of the flexible flat cable and contact with the movable body.

### BRIEF DESCRIPTION OF DRAWINGS

FIG. 1 is a schematic diagram showing an example of an overall configuration of a multifunction peripheral.

FIG. 2A is a side cross-sectional view showing an example of an internal structure of a scan unit.

FIG. 2B is a plan view of the scan unit as viewed from above with a pivotable cover opened.

FIG. 3 is a perspective view showing an example of a configuration of a reading unit and a flexible flat cable.

FIG. 4 is a perspective view showing an example of the configuration of the reading unit and the flexible flat cable.

FIG. 5 is a perspective view showing an example of the configuration of the reading unit and the flexible flat cable.

FIG. 6 is a top view of a portion VI in FIG. 5, showing a detailed structure of a facing member.

FIG. 7 is an enlarged view of a main part of FIG. 6.

FIG. 8 is a perspective view showing an example of the configuration of the reading unit and the flexible flat cable.

FIG. 9 is a perspective view showing a structure including a first support member in a housing, in which the reading unit and the flexible flat cable are omitted from the structure shown in FIGS. 3 to 8.

FIG. 10 is an enlarged view of a portion X in FIG. 9.

FIG. 11A is a cross-sectional view taken along a line XIA-XIA in FIG. 9, showing cross-sectional shapes of a first support member and a second support member.

FIG. 11B is a cross-sectional view taken along a line XIB-XIB in FIG. 9, showing cross-sectional shapes of the first support member and the second support member.

FIGS. 12A and 12B are views showing shapes of the first support member and the second support member, which are different from FIGS. 11A and 11B.

FIGS. 13A and 13B are views showing shapes of the first support member and the second support member, which are different from FIGS. 11A and 11B.

FIGS. 14A and 14B are views corresponding to a view seen from direction of an arrow XIV in FIG. 4, showing an arrangement position of the first support member.

FIGS. 15A, 15B and 15C are cross-sectional views of a support member in a case where protrusions are provided.

### DESCRIPTION

An embodiment of the present disclosure will be described with reference to the drawings.

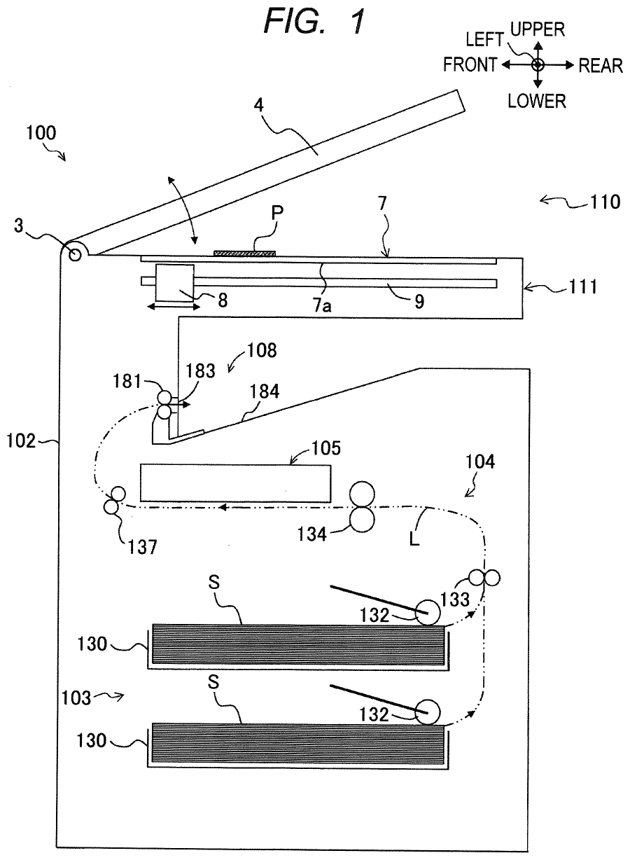

FIG. 1 shows an overall configuration of a multifunction peripheral (MFP) 100 according to an embodiment. In FIG. 1, the MFP 100 includes an apparatus main body 102. The apparatus main body 102 includes a supply unit 103, a conveyance unit 104, a print unit 105, a discharge unit 108, and a scan unit 110. In the present embodiment, for convenience of description, a side on which the discharge unit 108 is disposed is referred to as “front”, a side on which the conveyance unit 104 is disposed is referred to as “rear”, a side on which the supply unit 103 is disposed is referred to as “lower”, and a side on which the scan unit 110 is disposed is referred to as “upper”.

The supply unit 103 includes a plurality of sheet feed trays 130 detachably attached to a lower portion of the apparatus main body 102. The sheet feed trays 130 accommodate recording sheets S to be printed. Various types of sheet feed trays 130 are detachably attachable to the lower portion of the apparatus main body 102.

In the lower portion of the apparatus main body 102, a sheet feed roller 132 is disposed corresponding to each sheet feed tray 130. Inside the MFP 100, a conveyance path L is formed from the sheet feed roller 132 to the discharge unit 108 via the conveyance unit 104 and the print unit 105. The sheet feed roller 132 takes out the recording sheet S in the sheet feed tray 130 one sheet at a time, and conveys the recording sheet S toward the conveyance unit 104 and the print unit 105 along the conveyance path L.

The conveyance unit 104 holds the recording sheet S supplied by the supply unit 103 and conveys the recording sheet S to the print unit 105. The conveyance unit 104 includes conveyance rollers 133 and 134 driven by a motor (not shown). The recording sheet S conveyed by the sheet feed roller 132 is conveyed by the conveyance rollers 133 and 134 toward the print unit 105 along the conveyance path L.

The print unit 105 performs printing by forming an image on the recording sheet S conveyed by the conveyance unit 104 by a known method such as an electrophotographic method, an inkjet method, or a thermal transfer method. The recording sheet S conveyed by the print unit 105 is conveyed by the conveyance roller 137 toward a discharge roller 181 along the conveyance path L.

The discharge unit 108 discharges the recording sheet S conveyed by the print unit 105 to the outside of the MFP 100. The discharge unit 108 includes the discharge roller 181, a discharge port 183, and a discharge tray 184. The discharge roller 181 discharges the recording sheet S conveyed by the print unit 105 to the discharge tray 184 through the discharge port 183.

The scan unit 110 includes a flatbed 111 disposed above the apparatus main body 102, and a pivotable cover 4 disposed pivotably above the flatbed 111. The scan unit 110 is an example of an electronic device.

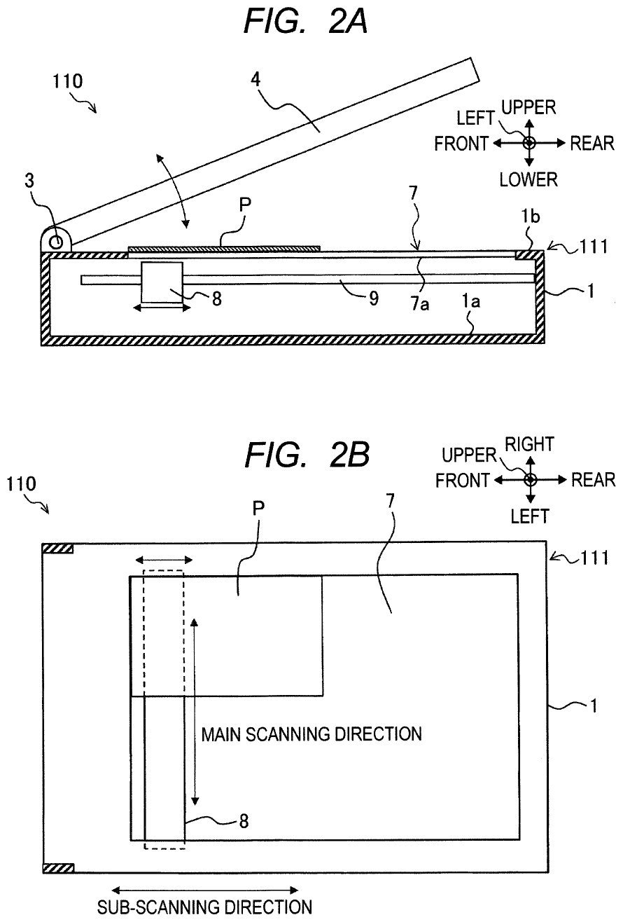

An example of a detailed configuration of the scan unit 110 is shown in FIGS. 2A and 2B. As shown in FIGS. 2A and 2B, the flatbed 111 includes a housing 1, a hinge 3, the pivotable cover 4, a glass plate 7, a reading unit 8, and a guide rail 9.

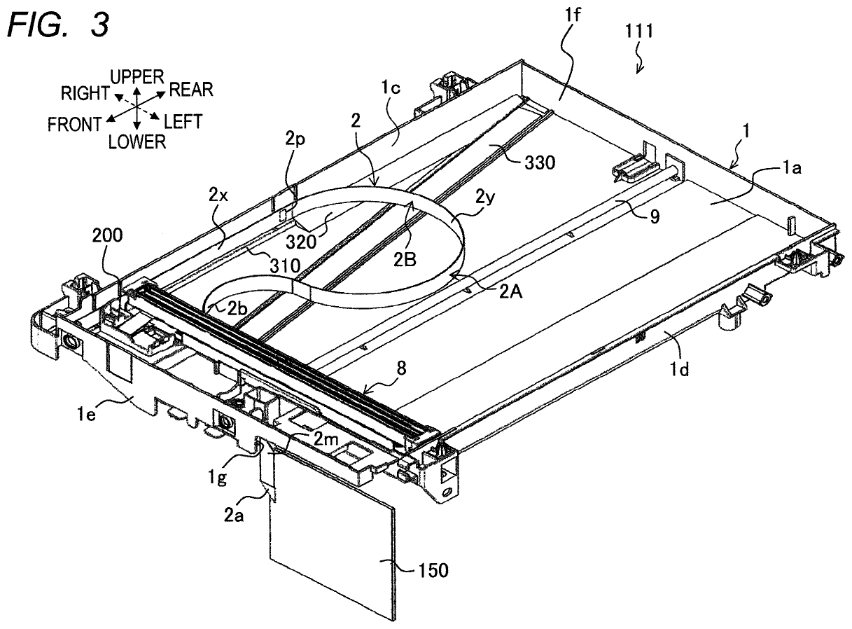

The housing 1 is, for example, a hollow box-shaped structure, and includes a bottom surface 1a and a top surface 1b. The housing 1 further includes a right side surface 1c, a left side surface 1d, a front side surface 1e, and a rear side surface 1f (see FIG. 3, for example). The right side surface 1c is an example of a side surface. The top surface 1b has a rectangular opening, and a rectangular glass plate 7 is disposed in the opening. The glass plate 7 is located above the reading unit 8, and the housing 1 supports the glass plate 7. A glass surface 7a on the lower side of the glass plate 7 is a substantially horizontal surface.

The reading unit 8 is disposed below the glass plate 7 and is movable along the guide rail 9. The reading unit 8 extends over an entirety of the glass plate 7 in the left-right direction, and includes a reading sensor (image sensor) configured by, for example, a CIS (contact image sensor). The reading unit 8 optically scans the entire lower surface of a document P by moving in the front-rear direction along the bottom surface 1a inside the housing 1 below the glass plate 7. The reading unit 8 includes a scanner head and a carriage. The scanner head is mounted on the carriage which is movable along the guide rail 9. The direction of one line that is scanned by the reading unit 8 at a time, that is, the left-right direction is referred to as a main scanning direction. The front-rear direction in which the reading unit 8 moves is referred to as a sub-scanning direction. The reading unit 8 is an example of a movable body, and the main scanning direction is an example of a third direction.

The pivotable cover 4 is pivotably attached via the hinge 3 arranged on the front end of the upper surface of the flatbed 111. The pivoting movement of the pivotable cover 4 about the hinge 3 enables the pivotable cover 4 to perform opening and closing operations with respect to the flatbed 111. The document P is placed on the glass plate 7 in a state where the pivotable cover 4 is opened, and the reading unit 8 scans the lower surface of the document P in a state where the pivotable cover 4 is closed.

FIGS. 3 to 5 show an example of the configuration of the reading unit 8 and the flexible flat cable 2. In FIGS. 3 to 5, the top surface 1b of the housing 1 and the glass plate 7 are not shown in order to show the internal configuration of the housing 1 of the flatbed 111.

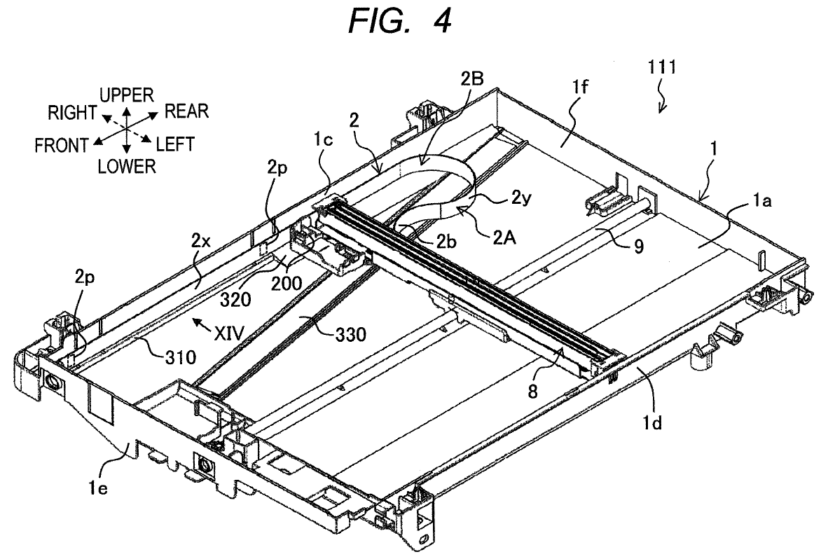

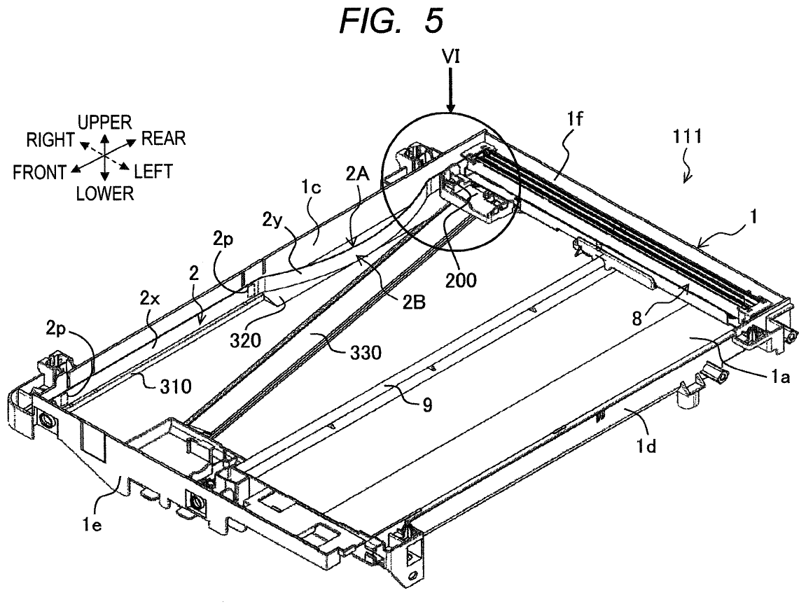

FIG. 3 shows a state where the reading unit 8 is located at an operation start position which is the frontmost position of an operation range. FIG. 5 shows a state where the reading unit 8 is located at an operation end position which is the rearmost position of the operation range. The forward is an example of a first direction and a particular direction, and the rearward is an example of a second direction. FIG. 4 shows a state where the reading unit 8 is located at an intermediate position between the operation start position and the operation end position.

The operation range of the reading unit 8 is set to correspond to the size of the document P which is a preset scanning target. As shown in FIGS. 3 to 5, the flexible flat cable 2 is disposed between the reading unit 8 and the housing 1. The flexible flat cable 2 electrically connects the reading sensor of the reading unit 8 and a controller 150 of the MFP 100. In FIGS. 4, 5, and 8, the controller 150 is not shown for the sake of simplicity.

The flexible flat cable 2 is formed by, for example, sandwiching a plurality of conductors arranged at regular intervals with plastic film tapes in the thickness direction and thermally welding tape bonding surfaces by thermal welding or an adhesive. The flexible flat cable 2 is a cable made of a flexible material, and has a long rectangular shape when viewed from the thickness direction of the cable in an extended state. The flexible flat cable 2 is disposed such that the width direction of the flexible flat cable 2 is a direction crossing the bottom surface 1a of the housing 1, for example, the upper-lower direction. The flexible flat cable 2 has flat surfaces that are flat in the width direction, and the flat surfaces include one flat surface 2A and an other flat surface 2B.

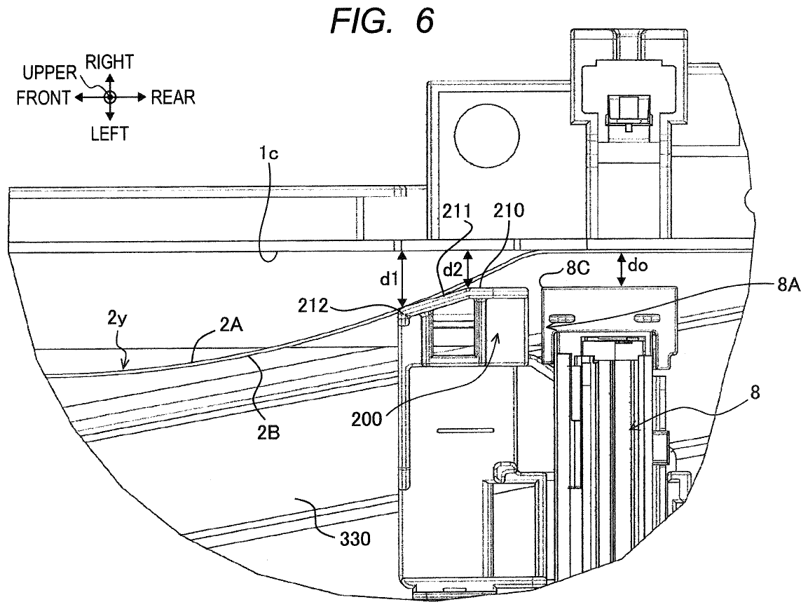

The flexible flat cable 2 includes a connection portion 2b at one end, a connection portion 2a at the other end, and an intermediate portion 2m between the connection portions 2a and 2b. An insertion opening 1g is formed in a front side surface 1e of the housing 1. The intermediate portion 2m of the flexible flat cable 2 extends through the insertion opening 1g of the front side surface 1e. The connection portion 2a is electrically connected to the controller 150 attached to the front side of the front side surface 1e of the housing 1. In this example, the connection portion 2b is attached to the rear side of the reading unit 8 and is electrically connected to the reading unit 8. The flexible flat cable 2 extends through a gap (that is, a gap of a distance do in FIG. 6) between the right side surface 1c and the reading unit 8. Alternatively, the connection portion 2a may be electrically connected to a circuit board (not shown).

The flexible flat cable 2 includes a held portion 2x between the intermediate portion 2m and the connection portion 2b, and includes a curved portion 2y between the held portion 2x and the connection portion 2b. The held portion 2x is a region of the flexible flat cable 2 where the one flat surface 2A and the right side surface 1c of the housing 1 keep facing each other, in other words, a region where the flexible flat cable 2 is stopped in a state where the flexible flat cable 2 remains facing the right side surface 1c. The held portion 2x is an example of a stationary range.

The held portion 2x includes attached portions 2p attached to the right side surface 1c. The attached portions 2p are located between the connection portion 2a and the connection portion 2b. In this example, the attached portions 2p are disposed near an end of the held portion 2x in the direction toward the connection portion 2a and near an end of the held portion 2x in the direction toward the connection portion 2b. The attached portions 2p are attached to the inner surface of the right side surface 1c by an adhesive.

The curved portion 2y is curved and moves between the attached portion 2p (that is closer to the connection portion 2b) and the connection portion 2b in accordance with the movement of the reading unit 8. In the state shown in FIGS. 3 and 4, for example, the curved portion 2y has a shape curved in a substantially arc shape. The length of a portion of the curved portion 2y in which the one flat surface 2A and the right side surface 1c face each other and extend in the front-rear direction (referred to as “facing length”) varies in accordance with the movement of the reading unit 8 in the front-rear direction. As shown in FIG. 3, when the reading unit 8 is located at the operation start position, the facing length is the shortest. As shown in FIG. 4, as the reading unit 8 moves rearward, the facing length gradually increases. As shown in FIG. 5, when the reading unit 8 is located at the operation end position, the facing length is the longest.

As described above, in the scan unit 110 of the present embodiment, the reading unit 8 moves toward the front and the rear along the bottom surface 1a of the housing 1. The connection portion 2b of the flexible flat cable 2 is attached to a particular portion of the reading unit 8 which moves as described above, and the connection portion 2a of the flexible flat cable 2 is attached to the controller 150 disposed outside the housing 1.

The flexible flat cable 2 extends from the connection portion 2a along the right side surface 1c of the housing 1, and then is curved back in an arc shape at the curved portion 2y so as to be separated from the right side surface 1c (see FIGS. 3 and 4). The connection portion 2b of the flexible flat cable 2 is attached to the reading unit 8. The connection portion 2b of the flexible flat cable 2 is also moved by the movement of the reading unit 8. By the movement, the flexible flat cable 2 is curved and deformed such that the arc shape of the folded curved portion 2y is expanded and contracted, and the range in which the one flat surface 2A and the right side surface 1c face each other is changed in size, thereby following the movement (see FIGS. 3, 4, and 5, for example).

At this time, the portion of the flexible flat cable 2 in which the one flat surface 2A and the right side surface 1c face each other and the range changes is not attached to the right side surface 1c of the housing 1. Thus, the portion of the flexible flat cable 2 may be curved without closely following the right side surface 1c and may contact the reading unit 8 (see FIG. 5). If such contact is repeated, the flexible flat cable 2 may be damaged.

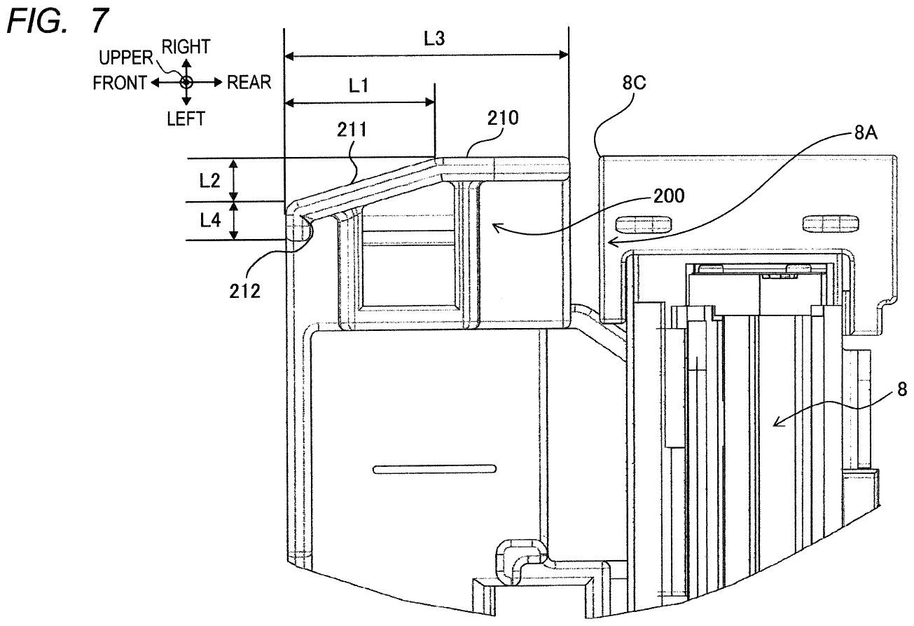

In the present embodiment, as one of the features for coping with this, a facing member 200 that moves together with the reading unit 8 is disposed at a particular portion on the front surface of the reading unit 8. The facing member 200 is also referred to as a facing wall or a guide. In this embodiment, the facing member 200 is disposed at a front end portion 8A of the reading unit 8. In other words, the facing member (guide) 200 is disposed at a corner 8C of the reading unit 8 near the right side surface 1c. A portion VI in FIG. 5 shows the detailed structure of the facing member 200. FIG. 6 shows a top view of the portion VI. FIG. 7 is an enlarged view of the main portion of FIG. 6.

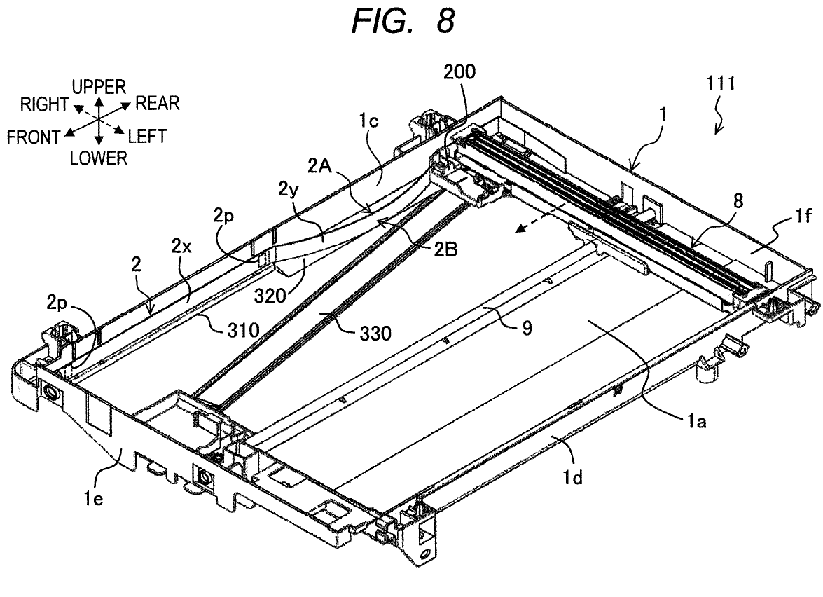

In FIGS. 5, 6, and 7, for example, the facing member 200 includes a facing surface 210. The facing surface 210 faces the other flat surface 2B in a state where the one flat surface 2A of the flexible flat cable 2 faces the right side surface 1c. The facing member 200 is disposed such that the facing surface 210 extends forward from the front end portion 8A of the reading unit 8. FIG. 8 shows the reading unit 8 and the flexible flat cable 2 when the reading unit 8 is returning from the operation end position to the operation start position. As shown in FIG. 8, when the reading unit 8 moves forward, the facing surface 210 of the facing member 200 contacts the other flat surface 2B of the flexible flat cable 2 and assists the movement of the one flat surface 2A of the flexible flat cable 2 toward the right side surface 1c (see a broken line arrow in FIG. 8). The size of the facing member 200 which contacts the flexible flat cable 2 in the upper-lower direction is greater than or equal to the width of the flexible flat cable 2 and less than or equal to the width of the flexible flat cable 2 plus 10 mm, or less than or equal to the width of the flexible flat cable 2 plus 5 mm, for example.

The facing surface 210 includes an inclined surface 211 configured to be away from the right side surface 1c in the main scanning direction, toward the front. As shown in FIG. 6, one end (inclination end point) of the inclined surface 211 close to the reading unit 8 is separated from the right side surface 1c by a second distance d2. The other end (inclination start point) of the inclined surface 211 away from the reading unit 8 is separated from the right side surface 1c by a first distance d1. The first distance d1 is greater than the second distance d2. The second distance d2 is equal to or greater than the distance do between the reading unit 8 and the right side surface 1c.

In FIG. 7, a dimension L1 of the inclined surface 211 in the sub-scanning direction is greater than or equal to 5 mm and less than or equal to 30 mm, for example. This is because, if the dimension L1 is smaller than 5 mm, the stress applied to the flexible flat cable 2 may be large when the flexible flat cable 2 contacts the inclined surface 211. A dimension L2 of the inclined surface 211 in the main scanning direction is greater than or equal to 3 mm and less than or equal to 10 mm, for example. This is because, if the dimension L2 is less than 3 mm, the stresses applied to the flexible flat cable 2 may be large when the flexible flat cable 2 contacts the inclined surface 211. For example, the wall thickness of the facing member (guide) 200 is 0.5 to 3.0 mm, and more preferably, 1.0 to 2.0 mm. Here, the wall thickness of the facing member 200 means the thickness of the wall having the facing surface 210 and the inclined surface 211.

In a case where the dimension L1 of the inclined surface 211 in the sub-scanning direction is relatively small with respect to an entire dimension L3 of the facing member 200 in the sub-scanning direction, the facing surface 210 may have a flat surface parallel to the sub-scanning direction as in FIG. 7, or may have a shape other than a flat surface.

The facing surface 210 includes a bent shape portion 212 that is bent to be away from the right side surface 1c at the front end of the facing surface 210 (that is, the front end of the inclined surface 211). In FIG. 7, a protruding length L4 of a bent portion of the bent shape portion 212 in the main scanning direction is greater than or equal to 1 mm in order to obtain the effect described later.

The rear end of the facing member 200 may be chamfered or rounded. This suppresses a situation in which the flexible flat cable 2 gets caught on the facing member 200 when the reading unit 8 moves rearward.

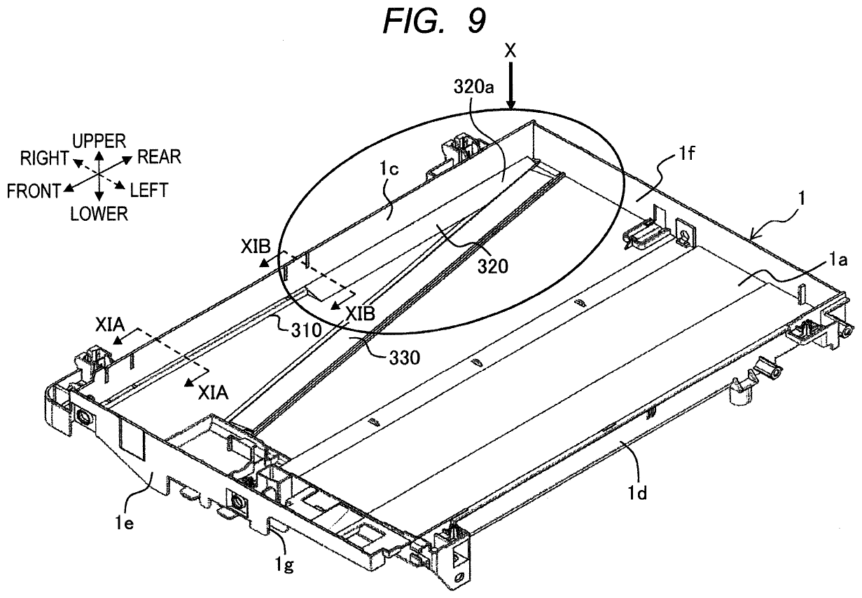

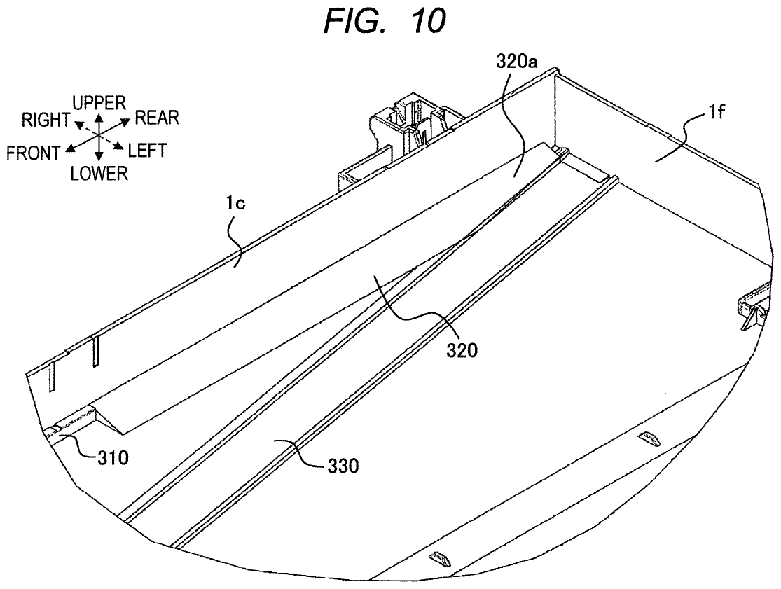

In the present embodiment, the scan unit 110 further includes a first support member 310 and a second support member 320. The first support member 310 and the second support member 320 extends in the front-rear direction in the housing 1. The first support member 310 and the second support member 320 extends along the right side surface 1c. More specifically, the first support member 310 and the second support member 320 are disposed along an inside corner formed by the right side surface 1c and the bottom surface 1a inside the housing 1. FIG. 9 is a perspective view showing the structure including the first support member 310 in the housing 1, in which the reading unit 8 and the flexible flat cable 2 are omitted. FIG. 10 is an enlarged view of a portion X in FIG. 9.

As described above, the flexible flat cable 2 includes the held portion 2x in which the one flat surface 2A and the right side surface 1c of the housing 1 keep facing each other. In a case where a part of the held portion 2x is fixed, such as a case where the attached portions 2p are disposed at two positions as in the embodiment, sagging may occur in the held portion 2x due to aging or temperature, for example, and the lower end of the flexible flat cable 2 may contact the bottom surface 1a of the housing 1. Thus, as shown in FIGS. 9 and 10, in the present embodiment, the first support member 310 supports the lower end of the flexible flat cable 2 between the connection portion 2a and the connection portion 2b. The height of the first support member 310 from the bottom surface 1a is equivalent to a gap distance between the bottom surface 1a and the flexible flat cable 2 at the connection portion 2b.

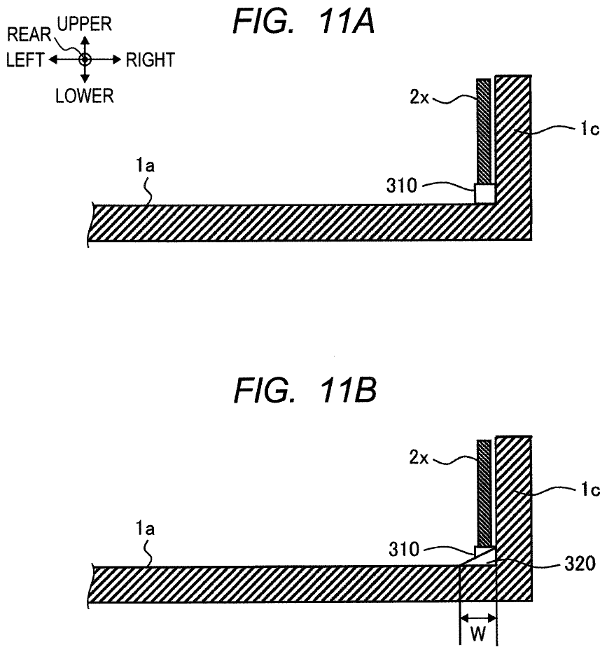

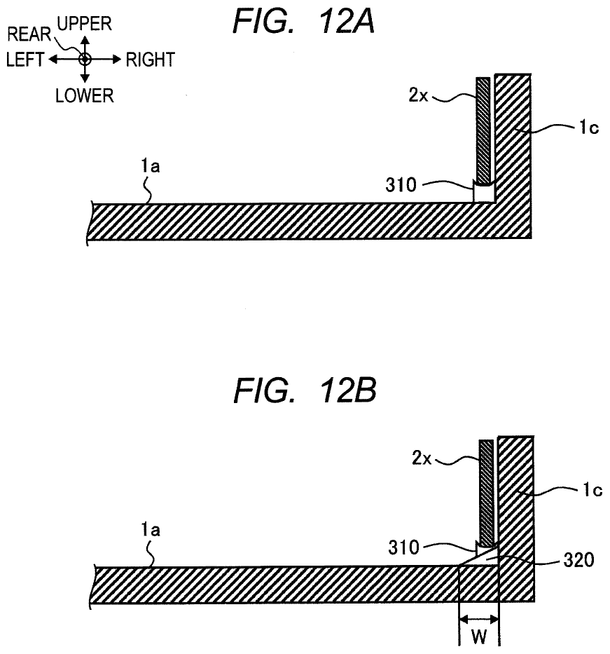

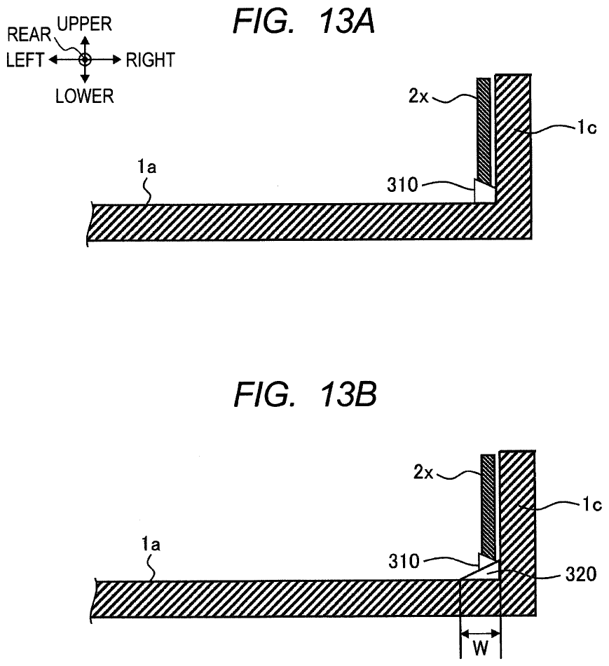

FIG. 11A is a cross-sectional view taken along a line XIA-XIA in FIG. 9, and FIG. 11B is a cross-sectional view taken along a line XIB-XIB in FIG. 9. As shown in FIGS. 11A and 11B, the cross-sectional shape of the first support member 310 is rectangular. Alternatively, the cross-sectional shape of the first support member 310 may be a concave shape in which a center portion is concave as shown in FIGS. 12A and 12B, or may be an inclined shape as shown in FIGS. 13A and 13B.

Although not shown, in addition to the member for supporting the lower end of the flexible flat cable 2 from below, the first support member 310 may include a member for pressing the upper end of the flexible flat cable 2 from above, or a member having an eaves type cross-sectional shape for holding the upper end from above, for example.

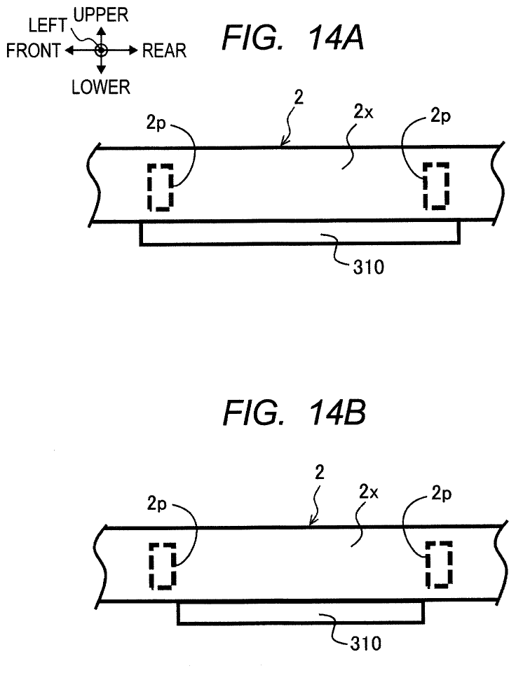

As shown in FIG. 14A, the first support member 310 may be disposed over a length in the front-rear direction corresponding to a section including and between the two attached portions 2p described above. FIG. 14A corresponds to a view taken in the direction of an arrow XIV in FIG. 4. Alternatively, as shown in FIG. 14B, the first support member 310 may be disposed over a length in the front-rear direction corresponding to an appropriate section between the two attached portions 2p and not including the two attached portions 2p.

As shown in FIGS. 9 and 3 to 8, the scan unit 110 includes a second support member 320. The second support member 320 extends in the front-rear direction so as to be continuous with the first support member 310 in the housing 1. The second support member 320 is located rearward of the first support member 310. As shown in FIGS. 3 to 8, the second support member 320 guides the lower end of the curved portion 2y of the flexible flat cable 2 so as to be separated from the bottom surface 1a.

In order to avoid interference with other components, the dimension of the second support member 320 in the left-right direction (that is, the width direction) may gradually decrease or the width of a part of the second support member 320 may be reduced. In the illustrated example, a dimension W of a rear region 320a of the second support member 320 in the left-right direction (see FIGS. 11B, 12B, and 13B) decreases toward the rear.

As shown in FIG. 10, the second support member 320 has an upward inclination in which the height from the bottom surface 1a increases toward the right side surface 1c. The cross-sectional shape of the upward inclination is not limited to a straight line as shown in FIGS. 11B, 12B, and 13B. That is, for example, the shape may be curved, stepped, or uneven, as long as the shape allows the flexible flat cable 2 to move (slide) up on the second support member 320 as mentioned above.

In order to prevent abrasion of the flexible flat cable 2 during the moving-up (sliding-up), a film having good abrasion resistance may be disposed on the inclined surface of the upward inclination. In this case, a recess may be formed in the bottom surface 1a of the housing 1 to allow an edge of the film to escape so that the flexible flat cable 2 is not caught by a step between the film and the bottom surface 1a of the housing 1. Further, a cushion material such as sponge may be disposed under the film to prevent stick-slip of the flexible flat cable 2.

In the present embodiment, the scan unit 110 further includes a support member (third support member) 330 on the bottom surface 1a of the housing 1. The support member 330 supports the lower end of the curved portion 2y of the flexible flat cable 2. The support member 330 is made of, for example, an appropriate material having good abrasion resistance. As shown in FIGS. 3 to 10, the support member 330 extends so as to obliquely cross the front-rear direction at a particular angle. The support member 330 extends obliquely from the rear region 320a (rear end) of the second support member 320 so as to be away from the right side surface 1c toward the front.

The support member 330 may have a film with good abrasion resistance on the upper surface thereof. Further, a cushion material such as a sponge may be disposed under the film to prevent the flexible flat cable 2 from stick-slip. Further, although the support member 330 extends obliquely in this example, the support member may have different arrangements, for example, depending on the position at which the flexible flat cable 2 protrudes from the reading unit 8. For example, the support member may extend perpendicularly from the rear side surface 1f. The support member may extend from the right side surface 1c (that is, from the first support member 310 or the second support member 320) so as to be parallel to the rear side surface 1f.

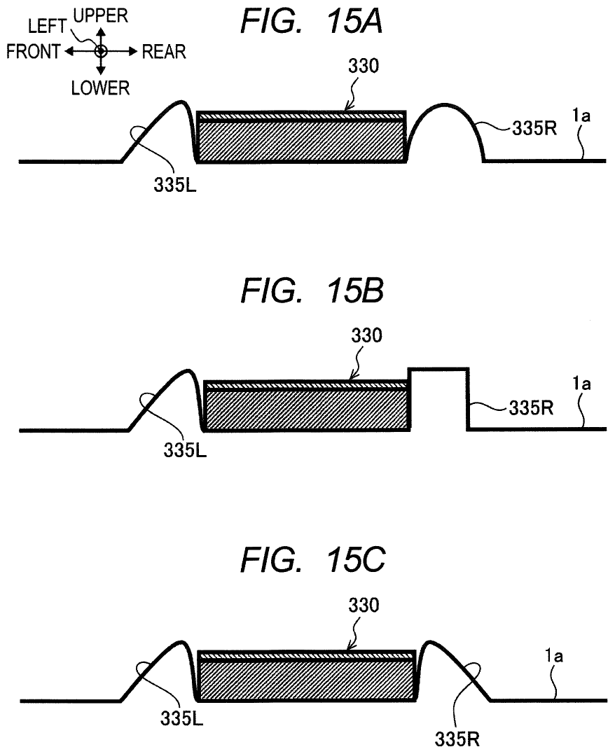

The support member 330 may have, on the sides in the right-left direction (the width direction), protrusions 335L and 335R having an inclined shape such that the flexible flat cable 2 moves up to the support member 330. FIGS. 15A, 15B and 15C are cross-sectional views of the support member 330 in the case where the protrusions 335L and 335R are provided. In these examples, from the viewpoint of positioning for convenience of manufacturing and assembling, the protrusions 335L and 335R are formed in a shape of sandwiching the support member 330. In the example of FIG. 15A, the cross-sectional shape of the protrusion 335L is substantially triangular, and the cross-sectional shape of the protrusion 335R is substantially circular arc. In the example of FIG. 15B, the cross-sectional shape of the protrusion 335L is substantially triangular, and the cross-sectional shape of the protrusion 335R is substantially rectangular. In the example of FIG. 15C, the cross-sectional shape of the protrusion 335L is substantially triangular, and the cross-sectional shape of the protrusion 335R is also substantially triangular.

By providing the protrusions 335L and 335R, when the flexible flat cable 2 repeatedly gets on and off the support member 330 due to movement of the reading unit 8, getting on and off the support member 330 by the flexible flat cable 2 is facilitated so that the flexible flat cable 2 is not caught by the support member 330. This reduces the occurrence of noise due to contact between the flexible flat cable 2 and the bottom surface 1a, the occurrence of abrasion debris due to sliding, and the occurrence of movement restriction of the reading unit 8 due to friction, for example.

As described above, in the present embodiment, the facing surface 210 of the facing member 200 assists the movement of the one flat surface 2A of the flexible flat cable 2 toward the right side surface 1c when the reading unit 8 moves toward the front. Thus, when the reading unit 8 moves toward the front, even if the flat surface of the flexible flat cable 2 is curved and not closely following the right side surface 1c, the movement is assisted such that the one flat surface 2A approaches the right side surface 1c, and the one flat surface 2A is brought close to the right side surface 1c of the housing 1. This reduces the contact between the flexible flat cable 2 and the reading unit 8, and reduces damage to the flexible flat cable 2.

In the present embodiment, the facing member 200 includes the inclined surface 211 configured to contact the flexible flat cable 2 and to be separated from the right side surface 1c toward the front (in the main scanning direction perpendicular to the right side surface 1c).

Thus, when assisting the movement of the flexible flat cable 2 as described above, the flexible flat cable 2 is smoothly moved toward the right side surface 1c while suppressing the curving of the flexible flat cable 2 while gradually applying force by using the inclination.

In the present embodiment, the facing surface 210 includes the bent shape portion 212 at the front end, which increases the contact area when the flexible flat cable 2 contacts the end portion of the facing member 200 and avoids point contact. This reduces the stress load applied to the flexible flat cable 2 at the time of contact.

If the second distance d2 of the facing surface 210 is smaller than the distance do between the reading unit 8 and the right side surface 1c, that is, if the facing surface 210 protrudes farther rightward than the reading unit 8, when the reading unit 8 moves rearward, the facing member 200 and the flexible flat cable 2 may contact each other and a load may be generated or the flexible flat cable 2 may be caught.

In the present embodiment, the second distance d2 of the facing surface 210 is equal to or greater than the distance do between the reading unit 8 and the right side surface 1c. That is, the right end surface of the facing member 200 and the right end surface of the reading unit 8 are separated from the right side surface 1c of the housing 1 by the same distance, or the right end surface of the facing member 200 is farther separated from the right side surface 1c of the housing 1 than the right end surface of the reading unit 8 is. Thus, the above-described problem is avoided.

In the present embodiment, the first support member 310 extending in the front-rear direction is disposed in the housing 1, and the first support member 310 supports the held portion 2x of the flexible flat cable 2 so as to be separated from the bottom surface 1a. This reduces stress and load generated by the flexible flat cable 2 sagging in the height direction. In addition, the first support member 310 facilitates the positioning of the flexible flat cable 2 in the upper-lower direction from the bottom surface 1a during the manufacturing and assembling.

For convenience of manufacturing and assembling, a part of the held portion 2x may be bonded to the inner surface (the right side surface 1c), instead of bonding the entirety of the held portion 2x of the flexible flat cable 2 to the inner surface. In the present embodiment, the held portion 2x is bonded to the inner surface at a portion near the end of the held portion 2x in the direction toward the connection portion 2a and at a portion near the end of the held portion 2x in the direction toward the connection portion 2b. In this case, by providing the first support member 310, the first support member 310 supports the sagging of a non-bonded portion of the held portion 2x that is not bonded to the inner surface.

In the present embodiment, the attached portions 2p of the flexible flat cable 2 are bonded to the inner surface (the right side surface 1c) with an adhesive. This prevents the attached portions 2p from falling off from the first support member 310.

In the present embodiment, as described above, the first support member 310 supports the held portion 2x of the flexible flat cable 2 including the attached portions 2p attached to the right side surface 1c of the housing 1. The curved portion 2y of the flexible flat cable 2 is in a free state between the attached portion 2p (closer to the connection portion 2b) and the connection portion 2b. Thus, if the curved portion 2y is spaced from the bottom surface 1a without any support member for supporting from the bottom surface 1a, the curved portion 2y may be sagged by its own weight and may contact the bottom surface 1a of the housing 1. In the present embodiment, the second support member 320 is disposed to separate the curved portion 2y of the flexible flat cable 2 from the bottom surface 1a, thereby avoiding contact with the bottom surface 1a.

In the present embodiment, the lower end of the flexible flat cable 2 is placed on and supported by the second support member 320 which is inclined upward toward the right side surface 1c. Thus, the curved portion 2y which is curved and deformed by the movement of the reading unit 8 and which follows the movement of the reading unit 8 is smoothly moved upward and guided, thereby reliably avoiding contact with the bottom surface 1a.

In the present embodiment, the support member 330 is disposed to support the lower end of the curved portion 2y of the flexible flat cable 2, and thus the curved portion 2y is less likely to contact the bottom surface 1a of the housing 1. This reduces the generation of noise due to the contact, the generation of abrasion debris due to sliding, and the generation of movement restriction of the reading unit 8 due to friction, for example.

In the present embodiment, the support member 330 is disposed on the bottom surface 1a of the housing 1 to extend obliquely relative to the front-rear direction, not in parallel with the front-rear direction, so as to cope with the above-described deformation behavior of the curved portion 2y. This reliably avoids contact between the curved portion 2y and the bottom surface 1a in a wide range in which the curved portion 2y moves around.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

Although the case where the present disclosure is applied to the scan unit 110 of the MFP 100 has been described above as an example, the application target of the present disclosure is not limited to the above. For example, the present disclosure may be applied to an inkjet printer. Further, the present disclosure may be applied to various electronic devices as long as the electronic devices have a structure in which a flexible flat cable is connected to a movable body.

In the above description, when there is a description such as “perpendicular”, “parallel”, and “flat”, the description does not have a strict meaning. That is, the terms “perpendicular”, “parallel”, and “flat” allow tolerances and errors in design and manufacturing, and have the meanings of “substantially perpendicular”, “substantially parallel”, and “substantially flat”, respectively.

In the above description, when the dimensions or sizes in appearance are described as “the same”, “equal”, and “different”, for example, the description does not have a strict meaning. That is, the terms “same”, “equal”, and “different” allow tolerances and errors in design and manufacturing, and have the meanings of “substantially the same”, “substantially equal”, and “substantially different”, respectively.

In addition to the above, the configurations and methods according to the above embodiment and the modifications may be appropriately combined and used.

What is claimed is

1. An electronic device comprising:
a housing including a side surface and a bottom surface;
a controller;
a movable body movable inside the housing in a first direction and in a second direction along the bottom surface, the first direction and the second direction being opposite to each other, the first direction and the second direction being parallel to the side surface;
a flexible flat cable having one end attached to the movable body and an other end attached to the controller, the flexible flat cable having one flat surface and an other flat surface opposite to each other; and
a facing member disposed at the movable body, the facing member including a facing surface that faces the other flat surface of the flexible flat cable in a state where the one flat surface of the flexible flat cable faces the side surface, the facing member being configured to assist movement of the one flat surface of the flexible flat cable toward the side surface when the movable body moves toward the first direction, the facing surface extending toward the first direction from an end of the movable body in the first direction.

2. The electronic device according to claim 1, wherein the facing surface includes an inclined surface configured to be away from the side surface toward a third direction perpendicular to the first direction;
wherein a first end of the inclined surface away from the movable body is separated from the side surface by a first distance;
wherein a second end of the inclined surface close to the movable body is separated from the side surface by a second distance; and
wherein the first distance is greater than the second distance.

3. The electronic device according to claim 2, wherein the facing member includes a bent shape portion at an end of the facing surface in the first direction, the bent shape portion being bent from the end of the facing surface to be away from the side surface.

4. The electronic device according to claim 2, wherein the second distance is equal to or greater than a distance between the movable body and the side surface.

5. The electronic device according to claim 1, wherein the flexible flat cable includes an attached portion that is attached to the side surface between the one end and the other end; and
wherein the electronic device further comprises a first support member extending in the first direction inside the housing, the first support member being configured to support a lower end of a portion of the flexible flat cable between the one end and the other end.

6. The electronic device according to claim 5, wherein the attached portion is bonded to the side surface by an adhesive.

7. The electronic device according to claim 5, wherein the flexible flat cable includes a curved portion between the attached portion and the one end, the curved portion being configured to move while being curved due to movement of the movable body; and
wherein the electronic device further comprises a second support member extending in the first direction in the housing, the second support member extending to be continuous with the first support member, the second support member being configured to guide a lower end of the curved portion of the flexible flat cable so as to be separated from the bottom surface.

8. The electronic device according to claim 7, wherein the second support member is inclined upward toward the side surface such that a height from the bottom surface increases toward the side surface.

9. The electronic device according to claim 1, wherein the flexible flat cable includes:
an attached portion attached to the side surface between the one end and the other end; and
a curved portion between the attached portion and the one end, the curved portion being configured to move while being curved due to movement of the movable body; and
wherein the electronic device further comprises a support member disposed at the bottom surface and configured to support a lower end of the curved portion of the flexible flat cable.

10. The electronic device according to claim 9, wherein the support member extends in a direction crossing the first direction.

11. An image reading apparatus comprising:
a housing including a side surface and a bottom surface;
a reading unit movable inside the housing;
a flexible flat cable attached to the reading unit; and
a guide disposed at a corner of the reading unit near the side surface,
the guide being configured to assist movement of the flexible flat cable toward the side surface when the reading unit moves toward a particular direction.

12. The image reading apparatus according to claim 11, wherein the guide includes an inclined surface configured to be away from the side surface toward the particular direction;
wherein an inclination start point of the inclined surface away from the reading unit in the particular direction is separated from the side surface by a first distance;
wherein an inclination end point of the inclined surface close to the reading unit in the particular direction is separated from the side surface by a second distance; and
wherein the first distance is greater than the second distance.

13. The image reading apparatus according to claim 12, wherein the guide includes a bent shape portion at the inclination start point of the guide, the bent shape portion being bent from the inclination start point to be away from the side surface.

14. The image reading apparatus according to claim 12, wherein the second distance is equal to or greater than a distance between the reading unit and the side surface.

15. The image reading apparatus according to claim 11, wherein the flexible flat cable includes an attached portion that is attached to a part of the side surface in the housing; and
wherein the image reading apparatus further comprises a first support member disposed along an inside corner in the particular direction, the inside corner being formed by the side surface and the bottom surface inside the housing, the first support member being configured to support a lower end of the flexible flat cable.

16. The image reading apparatus according to claim 15, wherein the attached portion is bonded to the side surface by an adhesive.

17. The image reading apparatus according to claim 15, wherein the flexible flat cable includes a curved portion between the attached portion and a connection portion connected to the reading unit, the curved portion being configured to move while being curved due to movement of the reading unit; and
wherein the image reading apparatus further comprises a second support member disposed in the particular direction in the housing, the second support member disposed to be continuous with the first support member, the second support member being configured to guide a lower end of the curved portion of the flexible flat cable so as to be separated from the bottom surface.

18. The image reading apparatus according to claim 17, wherein the second support member is inclined upward toward the side surface such that a height from the bottom surface increases toward the side surface.

19. The image reading apparatus according to claim 11, wherein the flexible flat cable includes:
an attached portion attached to the side surface;
a connection portion connected to the reading unit; and
a curved portion between the attached portion and the connection portion, the curved portion being configured to move while being curved due to movement of the reading unit; and
wherein the image reading apparatus further comprises a support member disposed at the bottom surface and configured to support a lower end of the curved portion of the flexible flat cable.

20. The image reading apparatus according to claim 19, wherein the support member extends in a direction crossing the particular direction.
